(19) United States
(12) Patent Application Publication
(10) Pub. No.: US 2025/0212142 A1
(43) Pub. Date: Jun. 26, 2025

(54) PRIMARY SOURCE STATUS REPORTING TO USER DEVICES

(71) Applicant: Nokia Technologies Oy, Espoo (FI)

(72) Inventors: Devaki CHANDRAMOUL, Dallas, TX (US); Troels Emil KOLDING, Aalborg (DK); Kari Juhani NIEMELÄ, Oulu (FI); Betsy COVELL, Naperville, IL (US); Rakash SIVASIVA GANESAN, Munich (DE); Pilar ANDRÉS MALDONADO, Aalborg (DK)

(21) Appl. No.: 18/849,973

(22) PCT Filed: Mar. 29, 2023
(86) PCT No.: PCT/IB2023/000248

§ 371 Date: Sep. 23, 2024

Related U.S. Application Data
(60) Provisional application No. 63/362,059, filed on Mar. 29, 2022.

(51) Int. Cl. H04W 56/00; H04W 64/00

(52) U.S. Cl. CPC H04W 56/001; H04W 64/006

(57) ABSTRACT

Method, apparatuses, and computer program products provide means for determining user equipment impacted by a network timing synchronization status and providing timing resiliency solutions. An example method includes: receiving, at a network entity, a network timing synchronization status request, wherein the network timing synchronization status request includes an indication of one or more user equipment (UE) to provide a time synchronization report to; determining, for each UE, one or more network entities to request a time synchronization status from; in response to receiving an indication of a primary source event, generating a time synchronization report indicative of the primary source event; and causing the time synchronization report to be provided to one or more impacted UEs.

### CROSS-REFERENCES TO RELATED APPLICATION(S)

The present application incorporates U.S. Provisional Application No. 63/362,059, filed Mar. 29, 2022, which is incorporated herein by reference in its entirety.

### TECHNOLOGICAL FIELD

An example embodiment relates generally to techniques for determining user equipment impacted by a network timing synchronization status and reporting the available timing synchronization status updates to impacted user equipment. Employing certain embodiments described herein, synchronous timing is maintained among network entities when a time source, such as GNSS timing, fails or otherwise degrades.

### BACKGROUND

Synchronization timing in a network is crucial to the proper functionality of the network. Various aspects of network functionality rely upon network time synchronization. For example, some services that utilize synchronization information (e.g., universal coordinated time (UTC)) via user equipment devices and/or a communication network, either as a main source or backup source, require the synchronization information to be up to date and accurate. Timing errors result in network connection errors along with application functionality issues. Therefore, it is important to provide an indication of timing synchronization updates to impacted user equipment.

### BRIEF SUMMARY

Various embodiments generally relate to techniques for determining user equipment affected by timing synchronization status updates and providing time synchronization reports to time synchronization solutions running on the user equipment in the event of time source degradation, recovery or failure.

According to an example embodiment, the network includes a fifth-generation technology standard (5G) network, and where the plurality of nodes includes one or more of a (Radio) Access Network ((R)AN) node (e.g., a Next Generation Radio Access Network (NG-RAN) node), an Access and Mobility Management Function (AMF), one or more of a Time Sensitive Communication and Time Synchronization Function (TSCTSF), an Application Function (AF), etc.

In one example embodiment, a method is provided that includes receiving, at a network entity, a network timing synchronization status request, wherein the network timing synchronization status request includes an indication of one or more user equipment (UE) to provide a time synchronization report to. In some embodiments, the method further includes determining, for each UE, one or more provider network entities to request a time synchronization status from. In some embodiments, the method further includes, in response to receiving an indication of a primary source event, generating a time synchronization report indicative of the primary source event. In some embodiments, the method further includes causing the time synchronization report to be provided to one or more impacted UEs.

In some embodiments, the method further includes determining, by the network entity, one or more impacted UEs which were impacted by the primary source event.

In some embodiments, the method further includes receiving, by another network entity, an indication of one or more impacted UEs which were impacted by the primary source event.

In some embodiments, the method further includes subscribing to an access network node timing synchronization status for an access network node or for each UE via a subscription request message. In some embodiments, the method further includes receiving a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the method further includes subscribing to UE location information for each UE via a location subscription request message.

In some embodiments, the method further includes determining binding for each UE with respect to an access network node.

In some embodiments, the method further includes causing a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In one example embodiment, an apparatus is provided that includes means for receiving, at a network entity, a network timing synchronization status request, wherein the network timing synchronization status request includes an indication of one or more user equipment (UE) to provide a time synchronization report to. In some embodiments, the apparatus further includes means for determining, for each UE, one or more provider network entities to request a time synchronization status from. In some embodiments, the apparatus further includes means for, in response to receiving an indication of a primary source event, generating a time synchronization report indicative of the primary source event. In some embodiments, the apparatus further includes means for causing the time synchronization report to be provided to one or more impacted UEs.

In some embodiments, the apparatus further includes means for determining, by the network entity, one or more impacted UEs which were impacted by the primary source event.

In some embodiments, the apparatus further includes means for receiving, by another network entity, an indication of one or more impacted UEs which were impacted by the primary source event.

In some embodiments, the apparatus further includes means for subscribing to an access network node timing synchronization status for an access network node or for each UE via a subscription request message. In some embodiments, the apparatus further includes means for receiving a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the apparatus further includes means for subscribing to UE location information for each UE via a location subscription request message.

In some embodiments, the apparatus further includes means for determining binding for each UE with respect to an access network node.

In some embodiments, the apparatus further includes means for causing a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and mobility management function (AMF), a session management function (SMF), a user plane function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In another example embodiment, an apparatus can be provided that comprises at least one processor and at least one memory including computer program code for one or more programs, the at least one memory and the computer program code configured to, with the at least one processor, cause the apparatus at least to receive, at a network entity, a network timing synchronization status request, wherein the network timing synchronization status request includes an indication of one or more user equipment (UE) to provide a time synchronization report to. In some embodiments, the apparatus may include the computer program code further configured to, with the at least one processor, cause the apparatus at least to determine, for each UE, one or more provider network entities to request a time synchronization status from. In some embodiments, the apparatus may include the computer program code further configured to, with the at least one processor, cause the apparatus at least to, in response to receiving an indication of a primary source event, generate a time synchronization report indicative of the primary source event. In some embodiments, the apparatus may include the computer program code further configured to, with the at least one processor, cause the apparatus at least to cause the time synchronization report to be provided to one or more impacted UEs.

In some embodiments, the apparatus may include the computer program code further configured to, with the at least one processor, cause the apparatus at least to determine, by the network entity, one or more impacted UEs which were impacted by the primary source event.

In some embodiments, the apparatus may include the computer program code further configured to, with the at least one processor, cause the apparatus at least to receive, by another network entity, an indication of one or more impacted UEs which were impacted by the primary source event.

In some embodiments, the apparatus may include the computer program code further configured to, with the at least one processor, cause the apparatus at least to subscribe to an access network node timing synchronization status for an access network node or for each UE via a subscription request message. In some embodiments, the apparatus may include the computer program code further configured to, with the at least one processor, cause the apparatus at least to receive a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the apparatus may include the computer program code further configured to, with the at least one processor, cause the apparatus at least to subscribe to UE location information for each UE via a location subscription request message.

In some embodiments, the apparatus may include the computer program code further configured to, with the at least one processor, cause the apparatus at least to determine binding for each UE with respect to an access network node.

In some embodiments, the apparatus may include the computer program code further configured to, with the at least one processor, cause the apparatus at least to cause a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and mobility management function (AMF), a session management function (SMF), a user plane function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In another example embodiment, a computer program product can be provided that comprises at least one non-transitory computer-readable storage medium having computer-executable program code instructions stored therein, the computer-executable program code instructions comprising program code instructions configured, upon execution, to receive, at a network entity, a network timing synchronization status request, wherein the network timing synchronization status request includes an indication of one or more user equipment (UE) to provide a time synchronization report to. In some embodiments, the computer-executable program code instructions comprising program code instructions may further be configured, upon execution, to determine, for each UE, one or more provider network entities to request a time synchronization status from. In some embodiments, the computer-executable program code instructions comprising program code instructions may further be configured, upon execution, to, in response to receiving an indication of a primary source event, generate a time synchronization report indicative of the primary source event. In some embodiments, the computer-executable program code instructions comprising program code instructions may further be configured, upon execution, to cause the time synchronization report to be provided to one or more impacted UEs.

In some embodiments, the computer-executable program code instructions comprising program code instructions may further be configured, upon execution, to determine, by the network entity, one or more impacted UEs which were impacted by the primary source event.

In some embodiments, the computer-executable program code instructions comprising program code instructions may further be configured, upon execution, to receive, by another network entity, an indication of one or more impacted UEs which were impacted by the primary source event.

In some embodiments, the computer-executable program code instructions comprising program code instructions may further be configured, upon execution, to subscribe to an access network node timing synchronization status for an access network node or for each UE via a subscription request message. In some embodiments, the computer-executable program code instructions comprising program code instructions may further be configured, upon execution, to receive a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the computer-executable program code instructions comprising program code instructions may further be configured, upon execution, to subscribe to UE location information for each UE via a location subscription request message.

In some embodiments, the computer-executable program code instructions comprising program code instructions may further be configured, upon execution, to determine binding for each UE with respect to an access network node.

In some embodiments, the computer-executable program code instructions comprising program code instructions may further be configured, upon execution, to cause a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and mobility management function (AMF), a session management function (SMF), a user plane function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In another example embodiment, a method is provided which includes receiving a time synchronization report. The method further includes updating one or more configurations based at least in part on the time synchronization report.

In some embodiments, the method further includes storing the time synchronization report.

In some embodiments, the method further includes causing a grandmaster announcement update to be provided to an associated precise time protocol network.

In some embodiments, the method further includes causing a time source event report indicative of time source event to be provided to higher layers.

In some embodiments, the method further includes causing a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, an apparatus is provided which includes means for receiving a time synchronization report. The apparatus further includes means for updating one or more configurations based at least in part on the time synchronization report.

In some embodiments, the apparatus further includes means for storing the time synchronization report.

In some embodiments, the apparatus further includes means for causing a grandmaster announcement update to be provided to an associated precise time protocol network.

In some embodiments, the apparatus further includes means for causing a time source event report indicative of time source event to be provided to higher layers.

In some embodiments, the apparatus further includes means for causing a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, an apparatus can be provided that comprises at least one processor and at least one memory including computer program code for one or more programs, the at least one memory and the computer program code configured to, with the at least one processor, cause the apparatus at least to receive a time synchronization report. The apparatus may include the computer program code further configured to, with the at least one processor, cause the apparatus at least to update one or more configurations based at least in part on the time synchronization report.

In some embodiments, the apparatus may include the computer program code further configured to, with the at least one processor, cause the apparatus at least to store the time synchronization report.

In some embodiments, the apparatus may include the computer program code further configured to, with the at least one processor, cause the apparatus at least to cause a grandmaster announcement update to be provided to an associated precise time protocol network.

In some embodiments, the apparatus may include the computer program code further configured to, with the at least one processor, cause the apparatus at least to cause a time source event report indicative of time source event to be provided to higher layers.

In some embodiments, the apparatus may include the computer program code further configured to, with the at least one processor, cause the apparatus at least to cause a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, a computer program product can be provided that comprises at least one non-transitory computer-readable storage medium having computer-executable program code instructions stored therein, the computer-executable program code instructions comprising program code instructions configured, upon execution, to receive a time synchronization report. The computer-executable program code instructions comprising program code instructions may further be configured, upon execution, to update one or more configurations based at least in part on the time synchronization report.

In some embodiments, the computer-executable program code instructions comprising program code instructions may further be configured, upon execution, to store the time synchronization report.

In some embodiments, the computer-executable program code instructions comprising program code instructions may further be configured, upon execution, to cause a grandmaster announcement update to be provided to an associated precise time protocol network.

In some embodiments, the computer-executable program code instructions comprising program code instructions may further be configured, upon execution, to cause a time source event report indicative of time source event to be provided to higher layers.

In some embodiments, the computer-executable program code instructions comprising program code instructions may further be configured, upon execution, to cause a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, a method is provided which includes receiving, by a network entity, an indication to provide a time synchronization report to one or more user equipment (UEs). The method further includes providing a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

In another example embodiment, an apparatus is provided which includes means for receiving, by a network entity, an indication to provide a time synchronization report to one or more user equipment (UEs). The apparatus further includes means for providing a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

In another example embodiment, an apparatus can be provided that comprises at least one processor and at least one memory including computer program code for one or more programs, the at least one memory and the computer program code configured to, with the at least one processor, cause the apparatus at least to receive, by a network entity, an indication to provide a time synchronization report to one or more user equipment (UEs). The apparatus may include the computer program code further configured to, with the at least one processor, cause the apparatus at least to provide a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

In another example embodiment, a computer program product can be provided that comprises at least one non-transitory computer-readable storage medium having computer-executable program code instructions stored therein, the computer-executable program code instructions comprising program code instructions configured, upon execution, to receive, by a network entity, an indication to provide a time synchronization report to one or more user equipment (UEs). The computer-executable program code instructions comprising program code instructions may further be configured, upon execution, to cause the apparatus at least to provide a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings, which are not necessarily drawn to scale. The components illustrated in the accompanying drawings may or may not be present in certain embodiments described herein. Some embodiments may include fewer (or more) components than those shown in the drawings.

FIG. 1 illustrates an overview of an example 5G internal clock and generalized Precision Time Protocol ((g)PTP) distribution architecture, in accordance with various embodiments;

FIG. 2 illustrates an overview of an example mobile network (e.g., 5GS), in accordance with various embodiments;

FIG. 3 provides a block diagram of an example apparatus that may facilitate fault-tolerant time signal degradation through a mitigation framework, in accordance with various embodiments;

FIGS. 4A-B illustrates a message flow diagram in an instance a TSCTSF is binding timing synchronization updates from the (R)AN, in accordance with various embodiments;

FIG. 5 illustrates a message flow diagram in an instance an AMF is binding timing sync updates from the (R)AN, in accordance with various embodiments;

FIG. 6 illustrates a message flow diagram in an instance the 5GS is already configured for network time synchronization reporting using an SIB9 based notification, in accordance with various embodiments;

FIG. 7 illustrates a message flow diagram in an instance the 5GS is already configured for network time synchronization reporting using an RRC based notification, in accordance with various embodiments;

FIG. 8 illustrates a message flow diagram in an instance the 5GS is already configured for network time synchronization reporting using an NAS based notification, in accordance with various embodiments;

FIG. 9 depicts example information which may be included in a time synchronization report, in accordance with various embodiments;

FIG. 10 illustrates an example workflow of various components of a communication system in accordance with an example embodiment;

FIG. 11 illustrates an example workflow of various components of a communication system in accordance with an example embodiment; and

FIG. 12 illustrates an example workflow of various components of a communication system in accordance with an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” “electronic information,” “signal,” “command,” and similar terms may be used interchangeably to refer to data capable of being captured, transmitted, received, and/or stored in accordance with various embodiments of the present disclosure. Thus, use of any such terms should not be taken to limit the spirit and scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, repeaters, and/or the like, sometimes referred to herein as a “network.” Similarly, where a first computing device is described herein as sending data to a second computing device, it will be appreciated that the data may be sent or transmitted directly to the second computing device or may be sent or transmitted indirectly via one or more intermediary computing devices, such as, for example, one or more servers, remote servers, cloud-based servers (e.g., cloud utilities), relays, routers, network access points, base stations, hosts, repeaters, and/or the like.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

Telecommunications networks generally employ a combination of synchronization methods to ensure reliability and robustness of phase/time synchronization, such as to avoid causing the (R)AN ((Radio) Access Network) timing to fail and to interfere with other nodes and devices. For example, local GNSS (Global Navigation Satellite System) receivers at (R)AN nodes combined with a PTP (Precision Time Protocol) transport network to support a GNSS-based physical layer clock located more centrally. In an example, according to International Telecom Union (ITU) standard ITU-T G8271.2, network limits are defined for time synchronization in packet networks with partial timing support from the network. In the Assisted Partial Timing Support (APTS) configuration, PTP is used as a backup timing source to a local reference (e.g., primary reference time clock (PRTC) based on the GNSS) for durations up to 72 hours. PTP is not intended to be used as the primary timing source. In the PTS configuration, however, PTP is used as the primary source of time to the end application. In such a mode, a local time reference (e.g., GNSS) is not available.

Some examples of the requirements that a (R)AN needs to fulfill include Cell phase sync accuracy (CPSA) of 3 microseconds among cells for TDD (Time Division Duplexing), and time alignment error between gNB (gNodeB) radio units (RUs) of less than 260 nanoseconds (category B) and 130 nanoseconds (category A) for Intra-band Carrier Aggregation. However, the GNSS signal is prone to degradation, such as due to physical blockage, interference, and threats such as jamming/spoofing attacks that can compromise network synchronization. The gNB is a well-suited network element to monitor GNSS signals, though it may have different implementations, such as whether the gNB relies on a directly attached GNSS or whether it connects to its timing master over a transport network.

The use of GNSS time delivery, particularly in GPS, is important in many sectors such as for positioning and/or navigation and timing (PNT) purposes. However, GNSS may experience several vulnerabilities due to environmental phenomena, malicious or incidental interference, spoofing, adjacent band interference, etc. The TSCTSF is needed to monitor and/or control timing resiliency monitoring within a communication system (e.g., 5GS). However, the TSCTSF will likely need to extract synchronization plane status from the network entities responsible for time distribution within the 5GS.

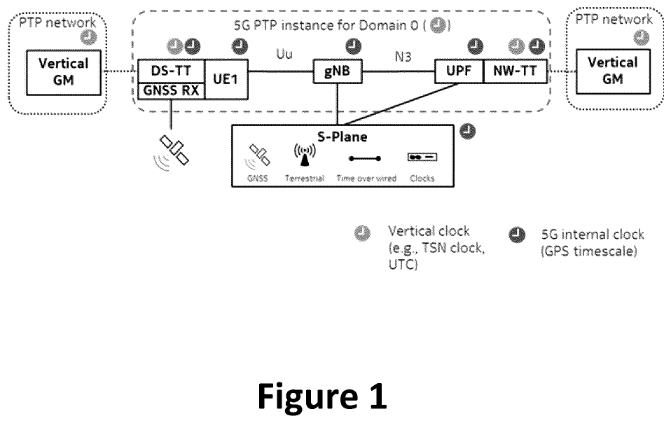

FIG. 1 illustrates an example 5G internal clock and (g)PTP distribution architecture. For control plane (C-plane) time distribution (i.e., 5G access stratum (AS) time distribution), access nodes (AN), such as radio access (RAN) nodes are responsible for providing 5GS timing information to the UE via a Uu interface. For example, (R)AN may provide 5G timing information using SIB9 or dedicated radio resource control (RRC) signaling. Alternatively, for user plane (U-plane) time distribution (i.e., using generalized precise time protocol ((g)PTP or PTP) messages), a (g)PTP grandmaster (GM) providing (g)PTP timing information to the UE and/or device side time sensitive network translator (DS-TT) via a user plane. The DS-TT at the UE side and the network side time sensitive network translator (NW-TT) at the network side (e.g., at the user plane function (UPF)) is responsible for supporting (g)PTP operation.

For C-plane time distribution of accurate absolute time, a (R)AN sends ReferenceTiemInfo-r16 (RTI) information element (IE) in a SIB9 or dedicated RRC signaling as part on downlink (DL) information transfer. The SIB9 information elements are described in TS 38.331. It is then left to the (R)AN to determine whether the (R)AN will include RTI in SIB9. The (R)AN may become aware that it should transmit RTI to the UE in two instances. In a first instance, the (R)AN is configured from the core network (CN) side to always deliver RTI or to always deliver RTI to particular UEs. In another instance, the UE may request to receive RTI via a ReferenceTimeInfoPreference field in UEAssistanceInformation IE.

As baseline, uncertainty field contained in the ReferenceTimeInformation (RTI) information element indicates the uncertainty of the reference time information provided by the time field. This attribute can be used to describe the degradation of the 5G timing information disseminated to the UE, but if the 5GS is able to withstand a degradation/failure of its primary time source (using another source or because of its own holdover capabilities) but still be able to notify the UE that there is a current issue with the primary source (e.g., for traceability reasons or for monitoring), this attribute alone is not enough.

As described above, in 5GS, a single wireless timing solution will leverage multiple timing sources. Additionally, the 5GS communication may provide coordinated universal time (UTC), the GPS and the local time to the UE. For a device connected to a 5G modem, the 5G clock may be the primary time source or may be a back-up alternative. For both cases, if the UE has more than one time reference, it can use them to compare the time signals and determine if its primary time source is degrading, failing, or have recovered.

In the GNSS case for example, the GNSS receptors may have in-build features that enable a more resilient performance at the device side against GNSS vulnerabilities, such as multi-constellation GNSS support. Inclusion of all possible constellations is a key trend for GNSS timing receivers were the legacy use of single or dual GNSS (GPS/GPS+GLONASS) is reserved for applications with stringent power limitations or low performance requirements, or where regulations have not yet been updated to multi-constellation.

For other types of time sources, solutions may involve further processing at the device side (e.g. comparing inputs), calibration of the devices, setting up monitoring tools in the network, etc. A 5G UE, as a component of an E2E timing solution, is in a unique position to support and verify multiple sources leveraging 5GS timing synchronization status monitoring service.

Certain embodiments described herein provide enablers for a network, such as a fifth-generation technology standard (5G) network system (5GS), to determine UEs impacted by a network timing synchronization status. Additionally, current embodiments provide enablers with 5GS reporting to the UE of the available timing synchronization status updates beyond the uncertainty field available in current RTI. Employing certain embodiments described herein, synchronous timing is maintained among network entities when a time source, such as GNSS timing, fails or otherwise degrades.

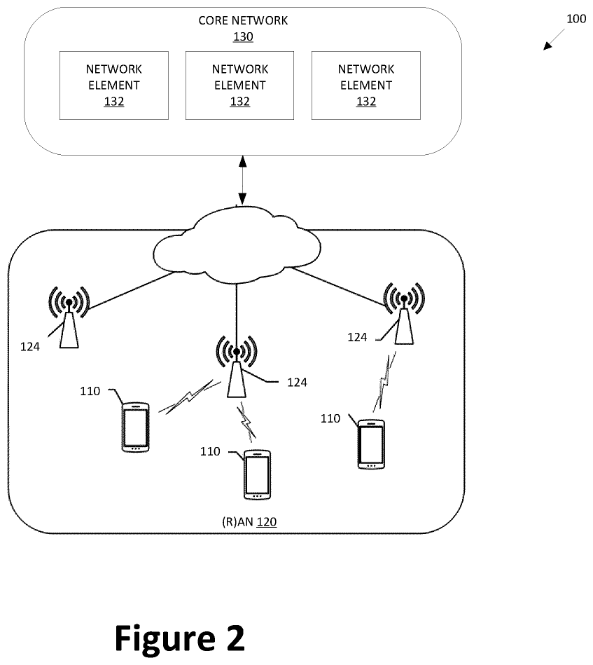

Referring now to FIG. 2, an example mobile network 100 is illustrated. Mobile network 100 (also referred to as a cellular network) is a type of network where at least the last link is wireless, and provides timing, voice, and/or data services to a plurality of devices. Mobile network 100 may be a Third Generation (3G), a Fourth Generation (4G), and/or a next generation (e.g., Fifth Generation, or 5G) network or any other of a variety of networks.

Mobile network 100 is illustrated as providing communication services to UEs 110. UEs 110 may be enabled for voice services, data services, Machine-to-Machine (M2M) or Machine Type Communications (MTC) services, Internet of Things (IoT) services, and/or other services. A UE 110 may be an end user device such as a mobile phone (e.g., smartphone), a tablet or PDA, a computer with a mobile broadband adapter, and/or the like.

Mobile network 100 includes one or more radio access networks ((R)AN 120) that communicate with UEs 110 over a radio interface. (R)AN 120 of one example embodiment may support Evolved-UMTS terrestrial Radio Access network (E-UTRAN) access, Wireless Local Area Network (WLAN) access, fixed access, satellite radio access, new Radio Access Technologies (RAT), and/or the like. As an example, (R)AN 120 may comprise an E-UT(R)AN or Next Generation (R)AN (NG-RAN) that includes one or more base stations 124 that are dispersed over a geographic area. A base station 124 may comprise an entity that uses radio communication technology to communicate with a UE on the licensed spectrum, and interface the UE with a core network 130. Base stations 124 in an E-UT(R)AN may be referred to as Evolved-NodeBs (eNodeB). Base stations 124 in a NG-(R)AN may be referred to as gNodeBs (NR base stations) and/or ng-eNodeBs (LTE base stations supporting a 5G Core Network). As another example, (R)AN 120 may comprise a WLAN that includes one or more Wireless Access Points (WAP). A WLAN is a network in which a UE is able to connect to a Local Area Network (LAN) through a wireless (radio) connection. A WAP is a node that uses radio communication technology to communicate with a UE over the unlicensed spectrum and provides the UE access to a core network. One example of a WAP is a Wi-Fi access point that operates on the 2.4 GHz or 5 GHz radio bands. The term “base station” then may refer to an eNodeB, a gNodeB, an ng-eNodeB, a WAP, and/or the like.

UEs 110 are able to attach to a cell of a (R)AN 120 to access a core network 130. (R)AN 120 therefore represents the radio interface between UEs 110 and core network 130. Core network 130 is the central part of mobile network 100 that provides various services to customers who are connected by (R)AN 120. One example of core network 130 is the Evolved Packet Core (EPC) network as described by the 3GPP for LTE. Another example of core network 130 is a 5G Core (5GC) network as described by the 3GPP. Core network 130 includes network entities 132, which may comprise servers, devices, apparatuses, or equipment (including hardware) that provide services for UEs 110. Network entities 132, in an EPC network, may comprise a Mobility Management Entity (MME), a Service Gateway (S-GW), a Packet Data Network Gateway (P-GW), and/or the like. Network entities 132, in a 5G network, may comprise an Access and Mobility Management Function (AMF), a Session Management Function (SMF), a User Plane Function (UPF), a Policy Control Function (PCF), a Unified Data Management (UDM), and/or the like.

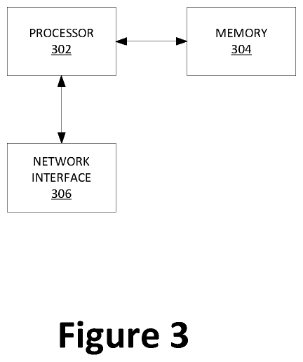

Referring now to FIG. 3, an example apparatus 300 is provided. The apparatus 300 may be an embodiment of a UE 110 and/or may be embodied by or otherwise associated with a UE 110, in some instances. Alternatively, the apparatus 300 may be an embodiment of a network element 132 or may be embodied by or otherwise associated with a network element 132, such as a PCF 260. In any regard, the apparatus 300 is configured to indicate and/or evaluate the applicability of routing parameters, such as URSP parameters. In an example embodiment, apparatus 300 is embodied by a network element 132, such as a PCF 260, and generates network applicability indications for parameters in a policy rule data object (e.g., a URSP) based at least in part on determining an applicability for the parameters to EPS networks. The apparatus 300 may then cause transmission of the policy rule data object including the network applicability indications to a UE 110, and the UE 110 may subsequently use the policy rule data object and evaluate the network applicability indications for the parameters of the policy rule data object in communicating via an EPS network. In another example embodiment, apparatus 300 is embodied by a UE 110 and receives a policy rule data object comprising network applicability indications associated with parameters. The apparatus 300 (e.g., UE 110) evaluates the network applicability indications to determine whether to ignore or consider various parameters and/or rule descriptors when communicating via an EPS network.

The apparatus 300 may include processor 302, memory 304, and network interface 306. The apparatus 300 may be configured to execute the operations described herein. Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may be configured to store information, data, content, applications, instructions, or the like for enabling the apparatus to carry out various functions in accordance with an example embodiment disclosed herein.

The processor 302 may be embodied in a number of different ways and may, for example, include one or more processing devices configured to perform independently. In some non-limiting embodiments, the processor 302 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 302 may be configured to execute instructions stored in the memory 304 and/or circuitry otherwise accessible to the processor 302, such as instructions for indicating and evaluating EPS applicability of URSP parameters of a policy rule data object. In some embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment disclosed herein while configured accordingly. Alternatively, as another example, when the processor 302 is embodied as an executor of software instructions, the instructions may specifically configure the processor 302 to perform the algorithms and/or operations described herein when the instructions are executed.

In some embodiments, the apparatus 300 may include input/output circuitry that may, in turn, be in communication with processor 302 to provide output to a user and/or other entity and, in some embodiments, to receive an indication of an input. The input/output circuitry may comprise a user interface and may include a display, and may comprise a web user interface, a mobile application, a query-initiating computing device, a kiosk, or the like. In some embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The network interface 306 may be any means such as a device or circuitry embodied in either hardware or a combination of hardware and software that is configured to receive and/or transmit data from/to a network and/or any other device, circuitry, or module in communication with the apparatus 300. In this regard, the network interface 306 may include, for example, a network interface for enabling communications with a wired or wireless communication network. For example, the network interface 306 may include one or more network interface cards, antennae, buses, switches, routers, modems, and supporting hardware and/or software, or any other device suitable for enabling communications via a network. Additionally, or alternatively, the network interface 306 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

An example embodiment described herein provides a consistent, fault tolerant timing degradation mitigation framework to enable a network, such as 5GS networks, to maintain timing through time source failures. Certain embodiments determine the UEs impacted by an update of the timing synchronization status and how to enable 5GS reporting of the time synchronization report to the UE, this providing mitigation strategies to ensure that the time synchronization services consumed at the device side are notified of the network timing synchronization status.

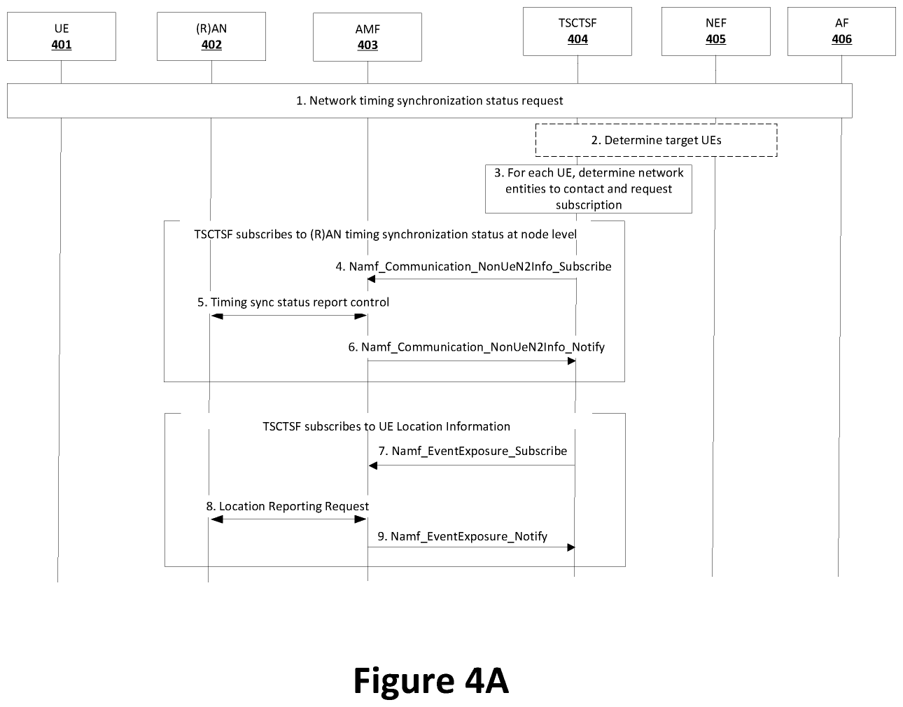

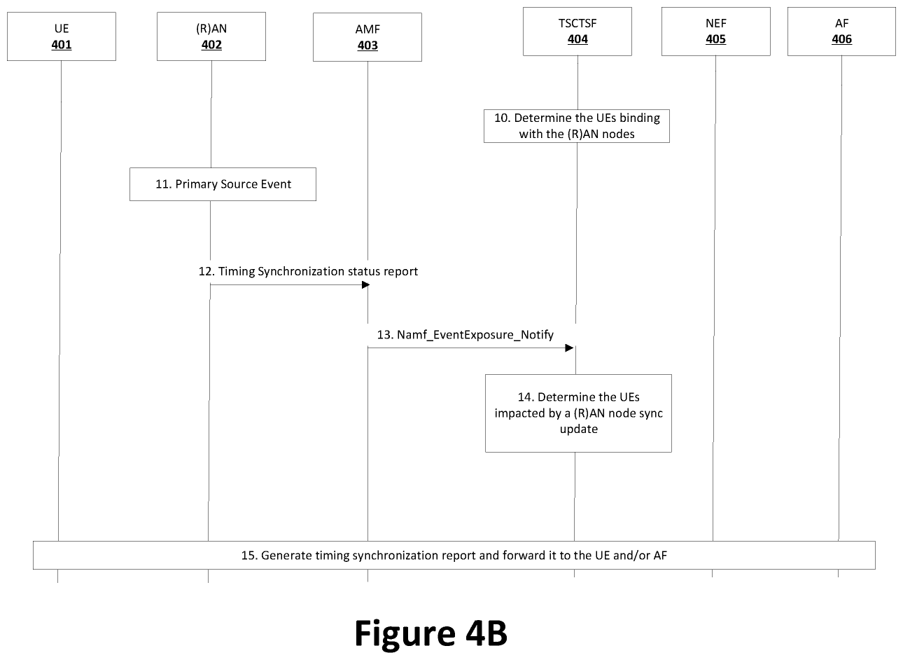

The 5GC may determine the UEs which require time source status updates. In particular the determination of the UEs to update may be determined. FIGS. 4A-B illustrates example transmissions between a UE and various network entities of a communication system for configuring a UE with a UE behavior policy.

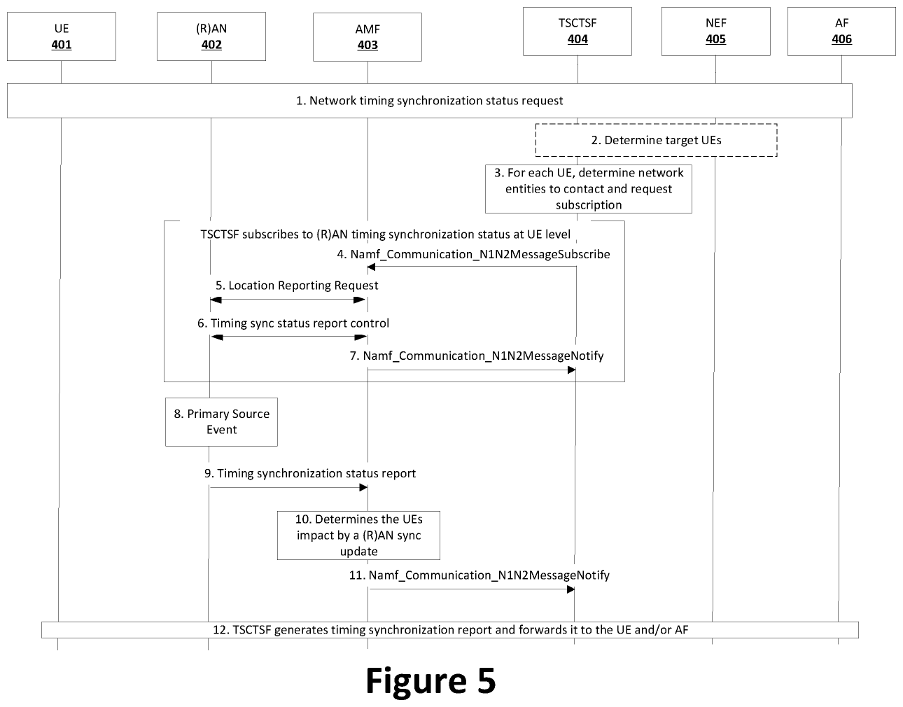

FIGS. 4A-B illustrate an example implementation of the method described herein for message flow where a TSCTSF is configured to bind the node level time synchronization report to specific UEs. The 5GS must bind the reporting update to the UEs that may be impacted. This updating may be based on the UEs in the coverage area for the (R)AN and/or whether the corresponding node is currently serving a UE. In the instance the TSCTSF subscribes at the AMF on a per RAN node level. The AMF forwards the received status report from the NG-RAN node to the TSCTSF. To determine the impacted UE(s), the TSCTSF needs subscription to UE's location service at the AMF. For UPF/NW-TT reports, the TSCTSF could be a consumer of Nupf_EventExposure service operation and directly retrieve the reports from the UPF, or could use the SMF to influence N4 node level reporting between SMF and UPF. Alternatively, as will described with respect to FIG. 5, an AMF may bind the node level time synchronization report to specific UEs.

At operation 1, a network synchronization status request may be received. The network synchronization status request may be received from one or more UEs or from an associated AF. In particular the TSCTSF 404 may receive the network synchronization status request.

In a first instance, an access function (AF) 406 may request network timing synchronization status targets for a UE and/or a subset or UEs. The AF may provide the received UE identifiers directly and/or by filtering information to target a subset of UEs based on spatial validity or data network name (DNN) connectivity. Alternatively, the 5GS network may notify all UEs in a coverage area and/or all UEs receiving time sync service via non-access stratum (NAS) signaling or RRC signaling.

Alternatively, a UE 401 may explicitly request network timing synchronization status monitoring. In particular, the UE 401 may supply the 5GS with subscription events or information elements it wants to be notified about. The UEs request may be forwarded to a TSCTSF 404, where the TSCTSF 404 may control the subscription to notifications and configure network time synchronization reports. The UE 401 may use NAS or RRC signaling to provide the request. In the instance the UE uses NAS signaling, the UE 401 may provide the request via NAS signaling via the AMF 403. The AMF 403 may process the request, identify the corresponding TSCTSF, and forward the request. In the instance the UE uses RRC signaling, a serving (R)AN node may forward the request to the TSCTSF 404 via AMF 403.

As shown in operation 2, in the instance the TSCTSF 404 receives the network timing synchronization status request from the AF 406, TSCTSF 404 may determine the target UEs. The target UEs may be determined based at least in part on the provided UE identifiers and/or DNN single network slice selection assistance information (S-NSSAI).

As shown in operation 3, for each UE, the TSCTSF 404 may determine the network entities to contact and/or request a subscription from. For example, the AMF, an associated session management function (SMF), and/or UPF (or NW-TT) corresponding to a UE of the one or more UEs, may be provided a subscription request message from the TSCTSF 404.

Operations 4-6 may allow the TSCTSF to subscribe the (R)AN timing synchronization status updates at the node level. When the 5GS is gathering network timing synchronization status from (R)AN nodes and/or from UPF NW-TT nodes, this occurs at the node level.

As shown in operation 4, the TSCTSF 404 may provide a subscription request message to an AMF 403. In particular, the subscription request message may be a Namf_Communication_NonUeN2Info_Subscribe message. The subscription request message may include the (R)AN node identities and/or (R)AN time synchronization reporting type which the TSCTSF 404 wishes to subscribe to. As shown in operation 5, a time synchronization reporting control message may be shared between the (R)AN 402 and AMF 403. As shown in operation 6, the AMF 403 may provide a subscription complete message to TSCTSF 404. The subscription complete message may indicate whether the TSCTSF was successfully subscribed to the requested network entities. The subscription complete message may be a Namf_communication_NonUeN2Info_Notify message.

Operations 7-9 may allow the TSCTSF to UE location information. For a UPF/NW-TT node, the TSCTSF may already be configured to determine the binding of the serving UPF/NW-TT and the UE as the UE has a (g)PTP service already controlled by the TSCTSF (operation standardized in Release-17).

For an NG-RAN node, next generation application protocol (NGAP) location reports provided by the NG-RAN to the AMF may include a tracking area identity (TAI) and/or cell identifier of the UE. Furthermore, a UE's status (connected mode, idle, etc.) may be determined to determine the UE's location and correlate the UE with the NG-RAN time synchronization report received. If a UE is in RRC-CONNECTED, the serving cell may be determined at the AMF by re-using the location report procedure already available in NGAP. Therefore, as soon as a report from a NG-RAN cell is received in the 5GC, the UE can be identified. If a UE is in RRC-INACTIVE, the NG-RAN determines the RAN Notification Area (RNA) (a list of Tracking Area(s) (TAs)), and thus, the AMF may determine the RNA where the UE is. When a report from a NG-RAN cell is received, the 5GC or NG-RAN will need to page the UE to check with cell the UE is camping within the RNA. If a UE is in RRC-IDLE, the AMF may determine the TA where the UE is. When a report from a NG-RAN cell is received, the 5GC will need to page the UE to check with cell the UE is camping within the TA.

As shown in operation 7, the TSCTSF 404 may provide a location subscription request message to AMF 403. The location subscription request message may include an event identifier in the location report. The location subscription request may be a Namf_EventExposure_Subscribe message. As shown in operation 8, a location reporting request message may be shared between the (R)AN 402 and AMF 403. As shown in operation 9, the AMF 403 may provide a location subscription complete message to TSCTSF 404. The location subscription complete message may indicate whether the TSCTSF was successfully subscribed to UE location information. The subscription complete message may be a Namf_EventExposure_Notify message.

As shown in operation 10, the TSCTSF 404 may determine the UEs binding with the (R)AN nodes. The binding of the UEs to the (R)AN nodes may be based at least in part on received subscription messages relating to (R)AN timing synchronization status subscription information and/or UE location information as discussed above with respect to operations 4-6 and 7-9, respectively.

At operation 11, a (R)AN 402 may detect a primary source event. The primary source event may be a (R)AN synchronization update. At operation 12, the (R)AN 402 may provide a time synchronization report to the AMF 403. At operation 13, the AMF 403 may provide an indication of a primary source event to the TSCTSF 404. The indication of a primary source event may be provided as a Namf_EventExposure_Notify message.

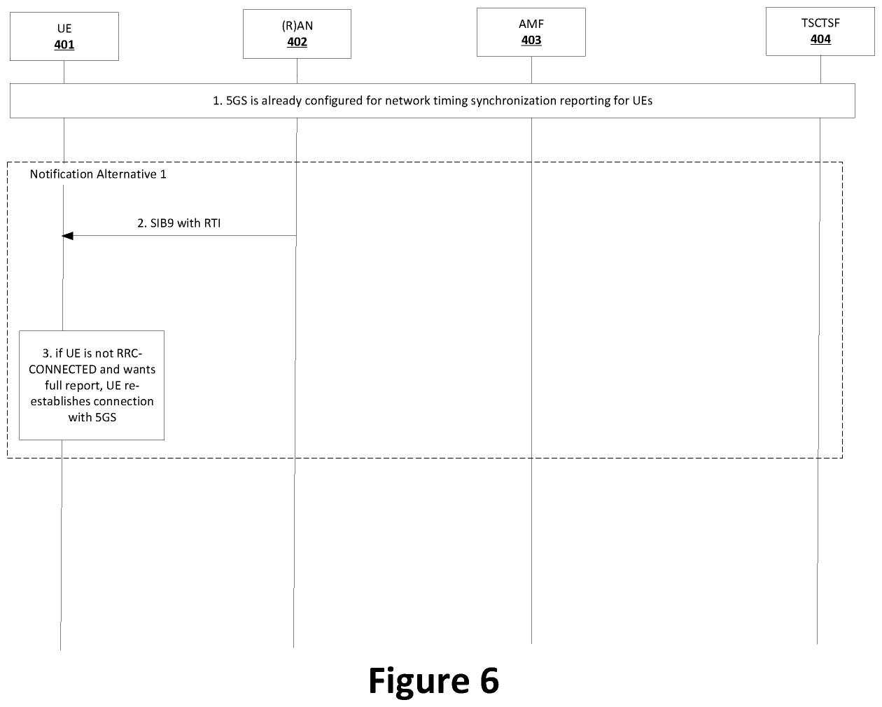

At operation 14, the TSCTSF 404 may determine the UEs impacted by the primary source event. At operation 15, the TSCTSF 404 may cause a time synchronization report to be provided to the one or more impacted UEs. The provision of the time synchronization report will be discussed in more detail with respect to FIGS. 6-8.

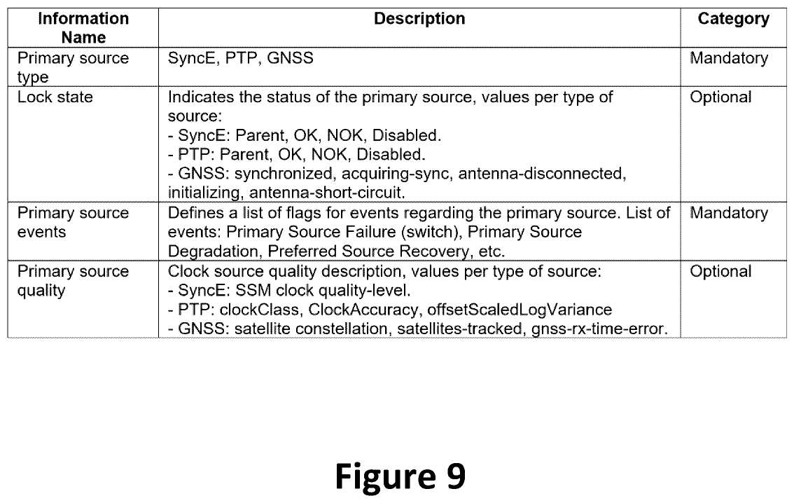

The time synchronization report may provide information relating to the timing information for a UE. FIG. 9 depicts an example of the information which may be included in the time synchronization report. UEs may be interested in just events or a more detailed description of the timing synchronization status the 5GS has for the 5G clock that is delivering to the UE via c-plane or u-plane methods. The information elements of the time synchronization report may also have an indication of whether the information elements are mandatory or optional. The time synchronization report may include information elements of a primary source type, lock state, primary source event, and/or primary source quality.

The lock state values may describe values which include 1) parent, which may be indicative that the signal from this source is currently used as a synchronization reference, 2) OK, which may be indicative that the signal from this source can be potentially used as a synchronization reference 3) NOK, which may be indicative that the signal from this source cannot be used as a synchronization reference, and/or 4) disabled, which may be indicative that source connection is not available.

In an instance the UE has configured (g)PTP distribution, the DS-TT may be already aware of the quality of the primary source as the attributes considered are part of the PTP signaling. That is, if the UPF is the GM of the (g)PTP time domain, the DS-TTs connected to the same (g)PTP time domain are aware of its performance.

FIG. 5 illustrates an example implementation of the method described herein for message flow where an AMF is configured to bind the node level time synchronization report to specific UEs. The TSCTSF may subscribe for receiving (R)AN time synchronization status at the AMF on a per UE level. The AMF is then responsible for determining the impacted UE(s) based on the UE(s) being served by the AMF. Per impacted UE, the AMF forwards the NG-RAN time synchronization status report to the TSCTSF subscribed to it for the UE(s) impacted and being served by the AMF.

Operations 1-3 may be performed similarly to operations 1-3 as described with respect to FIGS. 4A-B. Operations 4-7 may allow the TSCTSF to subscribe to (R)AN timing synchronization status at the UE level, as opposed to the node level of FIGS. 4A-B.

At operation 4, the TSCTSF 404 may provide a subscription request message to the AMF 403. The subscription request message may include the (R)AN node identities and/or (R)AN time synchronization reporting type which the TSCTSF 404 wishes to subscribe to. As shown in operation 5, a location reporting request message may be shared between the (R)AN 402 and AMF 403. As shown in operation 6, a time synchronization reporting control message may be shared between the (R)AN 402 and AMF 403. As shown in operation 7, the AMF 403 may provide a subscription complete message to TSCTSF 404. The subscription complete message may indicate whether the TSCTSF was successfully subscribed to the requested network entities and/or may include the UE identifiers. The subscription complete message may be a Namf_Communication_NIN2MessageNotify message.

At operation 8, a (R)AN 402 may detect a primary source event. The primary source event may be a (R)AN synchronization update. At operation 9, the (R)AN 402 may provide a time synchronization report to the AMF 403.

At operation 10, the AMF 403 may determine the UEs impacted by the primary source event. At operation 11, the AMF 403 may provide an indication of one or more impacted UEs which were impacted by the primary source event to the TSCTSF 404. The AMF 403 may provide the indication of one or more impacted UEs which were impacted by the primary source event using a Namf_CommunicationNIN2MessageNotify message. The Namf_CommunicationNIN2MessageNotify message may include the one or more UE identifiers of the impacted UEs and/or the time synchronization report.

At operation 12, the TSCTSF 404 may cause a time synchronization report to be provided to the one or more impacted UEs. The provision of the time synchronization report will be discussed in more detail with respect to FIGS. 6-8.

FIGS. 6-8 illustrates example implementations of methods described herein for message flow in which a time synchronization report is provided to the one or more impacted UEs. In some embodiments, the TSCTSF may generate the time synchronization report, as described above. Alternatively, a (R)AN node may generate the time synchronization report. Regardless of the entity generating the time synchronization report, the TSCTSF needs to be aware of the UE's subscription to this type of time synchronization reports and the TSCTSF will configure the (R)AN node with the proper configuration to allow for proper time synchronization reporting at a cell-level or UE-level basis. The (R)AN node may be configured to, when detecting a time synchronization status update, always report the time synchronization information to the TSCTSF and may additionally directly notify the UEs. When generating a report to the UE, depending if the UPF/NW-TT is involved in

the time synchronization distribution process (c-plane using access stratum signaling or u-plane using (g)PTP messages time distribution method is used to disseminate 5G clock to the UE), the TSCTSF may need to compose a time synchronization report only considering (R)AN node reports (if c-plane time distribution method is used) and UPF/NW-TT node report (if u-plane time distribution method is used).

FIG. 6 illustrates an example message flow for when a (R)AN node 402 uses SIB9 signaling to notify UEs. At operation 1, the 5GS may already be configured for network time synchronization reporting to UEs. At operation 2, the (R)AN 402, using a (R)AN node, may provide the time synchronization report to UE 401 using SIB9 signaling. SIB9 may only include a flag to notify the UEs in RRC_IDLE mode or RRC_INACTIVE mode that there is a network timing synchronization report. The SIB9 signaling may include a limited update report, which may only include the mandatory information elements of the time synchronization report. UEs in RRC_IDLE/INACTIVE may only require this type of report and they do not need to reestablish the connection with the 5GS. If the UE determines it wants more details, it can reestablish the connection with the 5GS and receive a full report via RRC or NAS signaling

At operation 3, an interested UE 401 can wake up (if not already in RRC_CONNECTED mode) and reestablish the connection with the 5GS and receive a full report via RRC or NAS signaling.

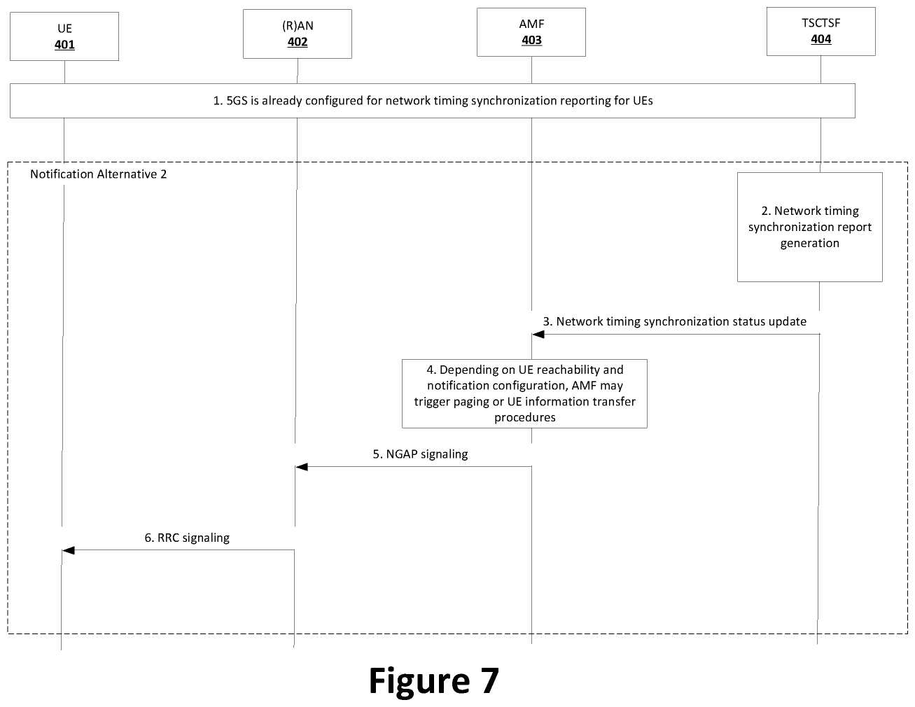

FIG. 7 illustrates an example message flow for when a (R)AN node 402 uses RRC signaling to notify UEs. At operation 1, the 5GS may already be configured for network time synchronization reporting to UEs. At operation 2, the TSCTSF 404 may generate the time synchronization report for the UEs. At operation 3, the TSCTSF 404 may notify the AMF 403 of the time synchronization report.

At operation 4, the AMF 403 may determine the reachability of each UE and/or a notification configuration for each UE.

In an instance the UE is in an IDLE mode and require the timing sync status reporting, AMF 403 may include the timing sync status report as part of the “Assistance Data for Paging” in NGAP signaling and forwards it to a (R)AN node of the (R)AN 402 at operation 5. Paging procedure or system information block (SIB) messages may be extended to include optional network time synchronization report to update the UE directly. Alternatively, the time synchronization report from the TSCTSF is used as the trigger by the AMF 403 to page the UE in IDLE mode. In this case, UE will just initiate a service request and the network provides timing sync status to the UE either using service accept or using RRC re-configuration procedure, which may include a timing sync status report.

In an instance the UE 401 is in in an INACTIVE mode and requires the time synchronization reporting, AMF 403 may include the time synchronization status report as part of an “Assistance Data for RRC Inactive” in NGAP signaling and forwards it to the (R)AN node of the (R)AN 402. A paging procedure may be extended to include optional network time synchronization report to update the UE directly. Alternatively, the time synchronization report from the TSCTSF 404 is used as the trigger to update the RRC inactive assistance data and the network may just update the UE with timing synchronization status.

In an instance the UE is in a Connected mode, RRC Reconfiguration or DL information transfer can be used for a UE in RRC-CONNECTED mode. The corresponding message needs to be extended to include time synchronization status report.

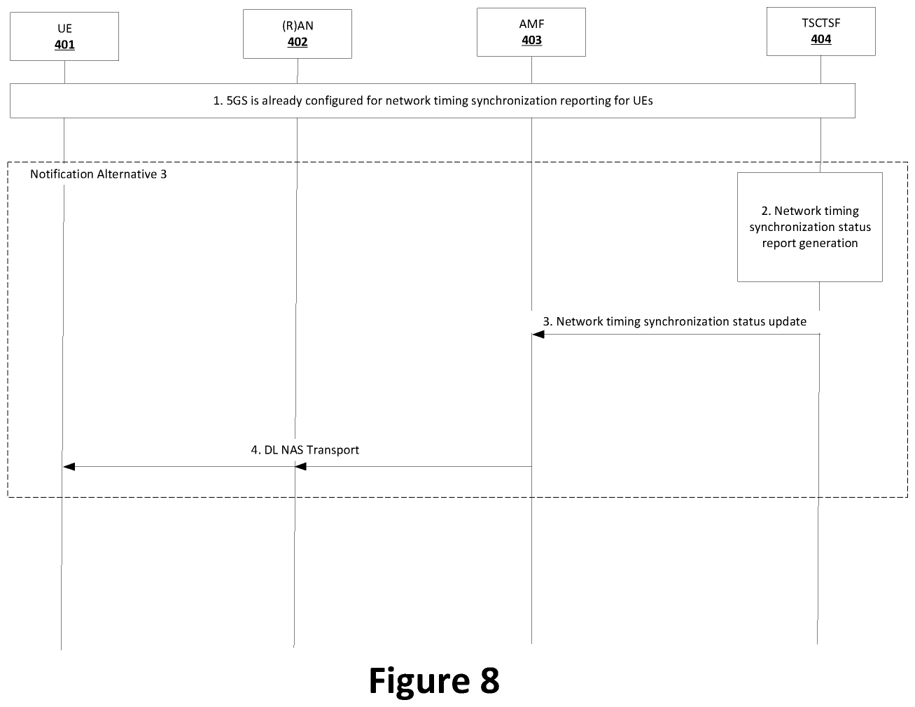

FIG. 8 illustrates an example message flow for when a TSCTSF 404 uses NAS reporting to notify UEs. NAS reporting may send the full network time synchronization report to the UE (i.e., via NG-RAN and UPF/NW-TT if applicable). At operation 1, the 5GS may already be configured for network time synchronization reporting to UEs. At operation 2, the TSCTSF 404 may generate the time synchronization report for the UEs. At operation 3, the TSCTSF 404 may notify the AMF 403 of the time synchronization report. At operation 4, the AMF 403 may use NAS reporting to notify UE 401 of the time synchronization report. If Downlink NAS Transport procedure is used, the AMF is responsible for triggering Downlink NAS Transport procedure towards the UE 401. Downlink NAS Transport procedure is used to send the network timing synchronization information as an optional field towards the UE.

Alternatively, if Port Management Information Container (PMIC) forwarding method is used, the TSCTSF 404 contacts SMF (not shown) to send the PMIC to the impacted UE/DS-TTs. The NAS PDU Session procedures are required thus the forwarding of network time synchronization report will be coupled to the PDU Session signaling.

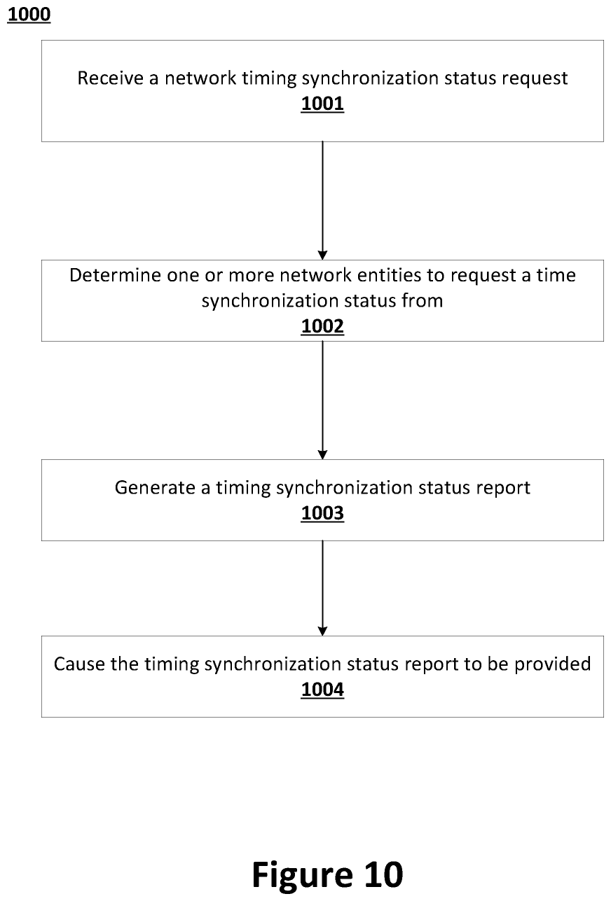

Referring now to FIG. 10, an example workflow of various components of a communication system are illustrated in accordance with example embodiments, such as a UE, a R (AN), an AMF, an SMF, a TSCTSF, NEF, AF, or other components previously described, e.g., in conjunction with other figures. Referring now to FIG. 10, a method 1000 is illustrated that can be carried out by one or more of the described entities that comprise means, such as the processor 302 and network interface 306 or the like, for receiving, at a network entity, a network timing synchronization status request, at 1001. The network timing synchronization status request may include an indication of one or more UE to provide a time synchronization report to. In some embodiments, the network timing synchronization status request is received from one or more user equipment. Alternatively, in some embodiments, the network timing synchronization status request is received from another network entity (e.g., AF).

The method 1000 may include means, such as processor 302 and/or the like, for determining, for each UE, one or more provider network entities to request a time synchronization status from, at 1002. The one or more provider network entities determined to request a time synchronization status from include one or more of an access network (AN) node, AMF, SMF, and/or UPF.

In some embodiments, the method further includes means, such as processor 302, network interface 306, and/or the like, for subscribing to an access network node timing synchronization status for each UE via a subscription request message. The subscription request message may include a time synchronization reporting type indicative of the type of time synchronization report requested. In some embodiments, the method further includes means, such as processor 302, network interface 306, and/or the like, for receiving a time synchronization report message in response to the subscription request message, wherein the time synchronization report message comprises a time synchronization report. In some embodiments, the method further includes means, such as processor 302, network interface 306, and/or the like, for subscribing to UE location information for each UE via a location subscription request message. In some embodiments, the method further includes means, such as processor 302, and/or the like, for determining binding for each UE with respect to an access network node.

The method 100 may further includes means, such as processor 302, network interface 306, and/or the like, for, in response to receiving an indication of a primary source event, generating a time synchronization report indicative of the primary source event, at 1003. In some embodiments, the method further includes determining, by the network entity, one or more impacted UEs which were impacted by the primary source event. Alternatively, in some embodiments, the method further includes means, such as processor 302, network interface 306, and/or the like, for receiving, by another network entity (e.g., an AMF), an indication of one or more impacted UEs which were impacted by the primary source event. The time synchronization report may be indicative of whether different elements are optional or mandatory.

The method 1000 may further includes means, such as processor 302, network interface 306, and/or the like, for, causing the time synchronization status report to be provided to one or more impacted UEs. In some embodiments, causing the time synchronization report to be provided includes: i) causing (R)AN to provide the time synchronization report or ii) causing an AMF to trigger paging or UE information transfer procedures. The time synchronization report may be provided via non-access stratum (NAS) signaling, SIB9 signaling, RRC signaling, or PDU Session procedures signaling.

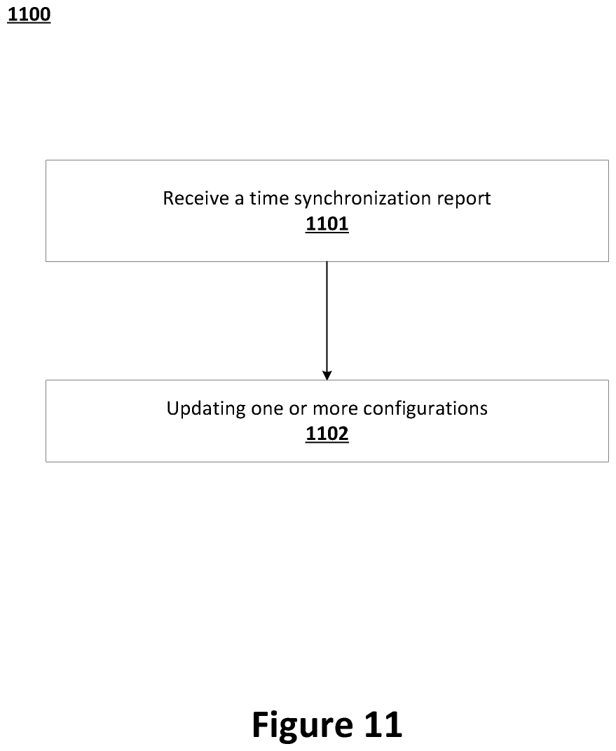

Referring now to FIG. 11, an example workflow of various components of a communication system are illustrated in accordance with example embodiments, such as a UE, a R(AN), an AMF, an SMF, a TSCTSF, NEF, AF, or other components previously described, e.g., in conjunction with other figures. Referring now to FIG. 11, a method 1100 is illustrated that can be carried out by one or more of the described entities that comprise means, such as the processor 302 and network interface 306 or the like, for receiving a time synchronization report, at 1101. In some embodiments, the method 1100 further includes means, such as processor 302, memory 304, network interface 306, and/or the like, for further includes storing the time synchronization report.

The method further includes means, such as processor 302, network interface 306, and/or the like, for updating one or more configurations based at least in part on the time synchronization report. If multiple time sources are available to the apparatus, updating the time synchronization report may include changing a primary time source from which time information is received in response to receipt of the network timing synchronization status request. Additionally or alternatively, updating the time synchronization report may include relying on holdover capabilities for time information in response to receipt of the network timing synchronization status request.

In some embodiments, the method further includes means, such as processor 302, network interface 306, and/or the like, for, in an instance the apparatus is the GM of a (g)PTP, causing a grandmaster announcement update to be provided to an associated generalized packet transfer protocol network.

In some embodiments, the method 1100 further includes means, such as processor 302, network interface 306, and/or the like, in an instance the apparatus relies on timestamping for application level actions, causing a time source event report (e.g., degradation, recovery, failure) indicative of time source event to be provided. The time source event report may be used to in higher layers that there may be an issue with application layer operation.

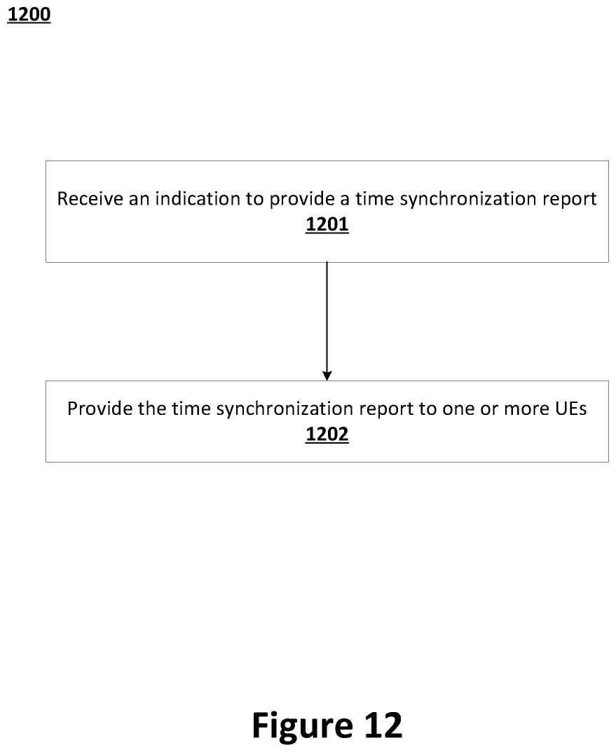

Referring now to FIG. 12, an example workflow of various components of a communication system are illustrated in accordance with example embodiments, such as a UE, a R(AN), an AMF, an SMF, a TSCTSF, NEF, AF, or other components previously described, e.g., in conjunction with other figures. Referring now to FIG. 12, a method 1200 is illustrated that can be carried out by one or more of the described entities that comprise means, such as the processor 302 and network interface 306 or the like, for receiving an indication to provide a time synchronization report to one or more UEs. In some embodiments, the indication to provide a time synchronization report is received from a TSCTSF. In some embodiments, the indication to provide a time synchronization report is received via NAS signaling.

In some embodiments, the method further includes means, such as processor 302, network interface 306, and/or the like, providing a time synchronization report to the one or more UEs. In some embodiments, the time synchronization report is provided via SIB9 signaling or RRC signaling. In some embodiments, providing the time synchronization report includes triggering paging or UE information transfer procedures. In some embodiments, the time synchronization report is provided in a PMIC.

FIGS. 10-12 illustrate flowcharts depicting operations according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures or operations described above may be embodied by computer program instructions. In this regard, the computer program instructions which embody the procedures or operations described above may be stored by a memory 304 of an apparatus (e.g., apparatus 300, UE 401, TSCTSF 404) employing an embodiment of the present invention and executed by a processor 302. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In one example embodiment, a method is provided that includes receiving, at a network entity, a network timing synchronization status request, wherein the network timing synchronization status request includes an indication of one or more user equipment (UE) to provide a time synchronization report to. In some embodiments, the method further includes determining, for each UE, one or more provider network entities to request a time synchronization status from. In some embodiments, the method further includes, in response to receiving an indication of a primary source event, generating a time synchronization report indicative of the primary source event. In some embodiments, the method further includes causing the time synchronization report to be provided to one or more impacted UEs.

In some embodiments, the method further includes determining, by the network entity, one or more impacted UEs which were impacted by the primary source event.

In some embodiments, the method further includes receiving, by another network entity, an indication of one or more impacted UEs which were impacted by the primary source event.

In some embodiments, the method further includes subscribing to an access network node timing synchronization status for an access network node or for each UE via a subscription request message. In some embodiments, the method further includes receiving a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the method further includes subscribing to UE location information for each UE via a location subscription request message.

In some embodiments, the method further includes determining binding for each UE with respect to an access network node.

In some embodiments, the method further includes causing a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and mobility management function (AMF), a session management function (SMF), a user plane function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In one example embodiment, an apparatus is provided that includes means for receiving, at a network entity, a network timing synchronization status request, wherein the network timing synchronization status request includes an indication of one or more user equipment (UE) to provide a time synchronization report to. In some embodiments, the apparatus further includes means for determining, for each UE, one or more provider network entities to request a time synchronization status from. In some embodiments, the apparatus further includes means for, in response to receiving an indication of a primary source event, generating a time synchronization report indicative of the primary source event. In some embodiments, the apparatus further includes means for causing the time synchronization report to be provided to one or more impacted UEs.

In some embodiments, the apparatus further includes means for determining, by the network entity, one or more impacted UEs which were impacted by the primary source event.

In some embodiments, the apparatus further includes means for receiving, by another network entity, an indication of one or more impacted UEs which were impacted by the primary source event.

In some embodiments, the apparatus further includes means for subscribing to an access network node timing synchronization status for an access network node or for each UE via a subscription request message. In some embodiments, the apparatus further includes means for receiving a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the apparatus further includes means for subscribing to UE location information for each UE via a location subscription request message.

In some embodiments, the apparatus further includes means for determining binding for each UE with respect to an access network node.

In some embodiments, the apparatus further includes means for causing a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In another example embodiment, an apparatus can be provided that comprises at least one processor and at least one memory including computer program code for one or more programs, the at least one memory and the computer program code configured to, with the at least one processor, cause the apparatus at least to receive, at a network entity, a network timing synchronization status request, wherein the network timing synchronization status request includes an indication of one or more user equipment (UE) to provide a time synchronization report to. In some embodiments, the apparatus may include the computer program code further configured to, with the at least one processor, cause the apparatus at least to determine, for each UE, one or more provider network entities to request a time synchronization status from. In some embodiments, the apparatus may include the computer program code further configured to, with the at least one processor, cause the apparatus at least to, in response to receiving an indication of a primary source event, generate a time synchronization report indicative of the primary source event. In some embodiments, the apparatus may include the computer program code further configured to, with the at least one processor, cause the apparatus at least to cause the time synchronization report to be provided to one or more impacted UEs.

In some embodiments, the apparatus may include the computer program code further configured to, with the at least one processor, cause the apparatus at least to determine, by the network entity, one or more impacted UEs which were impacted by the primary source event.

In some embodiments, the apparatus may include the computer program code further configured to, with the at least one processor, cause the apparatus at least to receive, by another network entity, an indication of one or more impacted UEs which were impacted by the primary source event.

In some embodiments, the apparatus may include the computer program code further configured to, with the at least one processor, cause the apparatus at least to subscribe to an access network node timing synchronization status for an access network node or for each UE via a subscription request message. In some embodiments, the apparatus may include the computer program code further configured to, with the at least one processor, cause the apparatus at least to receive a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the apparatus may include the computer program code further configured to, with the at least one processor, cause the apparatus at least to subscribe to UE location information for each UE via a location subscription request message.

In some embodiments, the apparatus may include the computer program code further configured to, with the at least one processor, cause the apparatus at least to determine binding for each UE with respect to an access network node.

In some embodiments, the apparatus may include the computer program code further configured to, with the at least one processor, cause the apparatus at least to cause a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and mobility management function (AMF), a session management function (SMF), a user plane function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In another example embodiment, a computer program product can be provided that comprises at least one non-transitory computer-readable storage medium having computer-executable program code instructions stored therein, the computer-executable program code instructions comprising program code instructions configured, upon execution, to receive, at a network entity, a network timing synchronization status request, wherein the network timing synchronization status request includes an indication of one or more user equipment (UE) to provide a time synchronization report to. In some embodiments, the computer-executable program code instructions comprising program code instructions may further be configured, upon execution, to determine, for each UE, one or more provider network entities to request a time synchronization status from. In some embodiments, the computer-executable program code instructions comprising program code instructions may further be configured, upon execution, to, in response to receiving an indication of a primary source event, generate a time synchronization report indicative of the primary source event. In some embodiments, the computer-executable program code instructions comprising program code instructions may further be configured, upon execution, to cause the time synchronization report to be provided to one or more impacted UEs.

In some embodiments, the computer-executable program code instructions comprising program code instructions may further be configured, upon execution, to determine, by the network entity, one or more impacted UEs which were impacted by the primary source event.

In some embodiments, the computer-executable program code instructions comprising program code instructions may further be configured, upon execution, to receive, by another network entity, an indication of one or more impacted UEs which were impacted by the primary source event.

In some embodiments, the computer-executable program code instructions comprising program code instructions may further be configured, upon execution, to subscribe to an access network node timing synchronization status for an access network node or for each UE via a subscription request message. In some embodiments, the computer-executable program code instructions comprising program code instructions may further be configured, upon execution, to receive a time synchronization report message in response to the subscription request message, wherein the time synchronization report message comprises a time synchronization report. In some embodiments, the subscription request message comprises a time synchronization reporting type indicative of the type of time synchronization report requested.

In some embodiments, the computer-executable program code instructions comprising program code instructions may further be configured, upon execution, to subscribe to UE location information for each UE via a location subscription request message.

In some embodiments, the computer-executable program code instructions comprising program code instructions may further be configured, upon execution, to determine binding for each UE with respect to an access network node.

In some embodiments, the computer-executable program code instructions comprising program code instructions may further be configured, upon execution, to cause a network timing synchronization report to be provided to the UE included in a port management information container (PMIC).

In some embodiments, the network timing synchronization status request is received from one or more user equipment. In some embodiments, the network timing synchronization status request is received from another network entity. In some embodiments, the one or more provider network entities determined to request a time synchronization status from include one or more of access network (AN) node, an access and mobility management function (AMF), a session management function (SMF), a user plane function (UPF), or Network Side Translator (NW-TT). In some embodiments, the network timing synchronization report is provided to the impacted UEs via non-access stratum (NAS) signaling, SIB9 signaling, RRC signaling, or PDU Session procedures signaling. In some embodiments, the network timing synchronization request indicates whether each information element included in the network timing synchronization status request are optional or mandatory in the time synchronization report. In some embodiments, the information elements of the network timing synchronization report comprise at least one of a primary source type, lock state, primary source event, or primary source quality.

In another example embodiment, a method is provided which includes receiving a time synchronization report. The method further includes updating one or more configurations based at least in part on the time synchronization report.

In some embodiments, the method further includes storing the time synchronization report.

In some embodiments, the method further includes causing a grandmaster announcement update to be provided to an associated precise time protocol network.

In some embodiments, the method further includes causing a time source event report indicative of time source event to be provided to higher layers.

In some embodiments, the method further includes causing a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, an apparatus is provided which includes means for receiving a time synchronization report. The apparatus further includes means for updating one or more configurations based at least in part on the time synchronization report.

In some embodiments, the apparatus further includes means for storing the time synchronization report.

In some embodiments, the apparatus further includes means for causing a grandmaster announcement update to be provided to an associated precise time protocol network.

In some embodiments, the apparatus further includes means for causing a time source event report indicative of time source event to be provided to higher layers.

In some embodiments, the apparatus further includes means for causing a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, an apparatus can be provided that comprises at least one processor and at least one memory including computer program code for one or more programs, the at least one memory and the computer program code configured to, with the at least one processor, cause the apparatus at least to receive a time synchronization report. The apparatus may include the computer program code further configured to, with the at least one processor, cause the apparatus at least to update one or more configurations based at least in part on the time synchronization report.

In some embodiments, the apparatus may include the computer program code further configured to, with the at least one processor, cause the apparatus at least to store the time synchronization report.

In some embodiments, the apparatus may include the computer program code further configured to, with the at least one processor, cause the apparatus at least to cause a grandmaster announcement update to be provided to an associated precise time protocol network.

In some embodiments, the apparatus may include the computer program code further configured to, with the at least one processor, cause the apparatus at least to cause a time source event report indicative of time source event to be provided to higher layers.

In some embodiments, the apparatus may include the computer program code further configured to, with the at least one processor, cause the apparatus at least to cause a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, a computer program product can be provided that comprises at least one non-transitory computer-readable storage medium having computer-executable program code instructions stored therein, the computer-executable program code instructions comprising program code instructions configured, upon execution, to receive a time synchronization report. The computer-executable program code instructions comprising program code instructions may further be configured, upon execution, to update one or more configurations based at least in part on the time synchronization report.

In some embodiments, the computer-executable program code instructions comprising program code instructions may further be configured, upon execution, to store the time synchronization report.

In some embodiments, the computer-executable program code instructions comprising program code instructions may further be configured, upon execution, to cause a grandmaster announcement update to be provided to an associated precise time protocol network.

In some embodiments, the computer-executable program code instructions comprising program code instructions may further be configured, upon execution, to cause a time source event report indicative of time source event to be provided to higher layers.

In some embodiments, the computer-executable program code instructions comprising program code instructions may further be configured, upon execution, to cause a network timing synchronization status request to be transmitted, wherein the time synchronization report is received in response to the network timing synchronization status request.

In some embodiments, updating the one or more configurations includes changing a primary time source from which time information is received in response to receipt of the network timing synchronization status request. In some embodiments, updating the one or more configurations includes relying on holdover capabilities for time information in response to receipt of the network timing synchronization status request. In some embodiments, the network timing synchronization request indicates whether different information elements are optional or mandatory in the time synchronization report.

In another example embodiment, a method is provided which includes receiving, by a network entity, an indication to provide a time synchronization report to one or more user equipment (UEs). The method further includes providing a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

In another example embodiment, an apparatus is provided which includes means for receiving, by a network entity, an indication to provide a time synchronization report to one or more user equipment (UEs). The apparatus further includes means for providing a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

In another example embodiment, an apparatus can be provided that comprises at least one processor and at least one memory including computer program code for one or more programs, the at least one memory and the computer program code configured to, with the at least one processor, cause the apparatus at least to receive, by a network entity, an indication to provide a time synchronization report to one or more user equipment (UEs). The apparatus may include the computer program code further configured to, with the at least one processor, cause the apparatus at least to provide a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

In another example embodiment, a computer program product can be provided that comprises at least one non-transitory computer-readable storage medium having computer-executable program code instructions stored therein, the computer-executable program code instructions comprising program code instructions configured, upon execution, to receive, by a network entity, an indication to provide a time synchronization report to one or more user equipment (UEs). The computer-executable program code instructions comprising program code instructions may further be configured, upon execution, to cause the apparatus at least to provide a time synchronization report to one or more UEs.

In some embodiments, the network entity is an access network node, an access and mobility management function, or a session management function. In some embodiments, the time synchronization report is provided via SIB9 signaling or radio resource connection (RRC) signaling. In some embodiments, providing the time synchronization report further comprises, triggering paging or UE information transfer procedures. In some embodiments, the indication to provide a time synchronization report is received via non-access stratum (NAS) signaling. In some embodiments, the time synchronization report is provided in a port management information container (PMIC).

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below. Other features, aspects, and advantages of the subject matter will become apparent from the description, the drawings, and the claims.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-87. (canceled)

88. A method comprising:
receiving, at a network entity, a network timing synchronization status request, wherein the network timing synchronization status request includes an indication of one or more user equipment (UE) to provide a time synchronization report to;
determining, for each UE, one or more provider network entities to request a time synchronization status from;
in response to receiving an indication of a primary source event, generating a time synchronization report indicative of the primary source event; and
causing the time synchronization report to be provided to one or more impacted UEs.

89. The method of claim 88, the method further comprising: determining, by the network entity, one or more impacted UEs which were impacted by the primary source event.

90. The method of claim 88, the method further comprising: receiving, by another network entity, an indication of one or more impacted UEs which were impacted by the primary source event.

91. The method of claim 88, wherein the network timing synchronization status request is received from another network entity.

92. The method of claim 88, the method further comprising: subscribing to an access network node timing synchronization status for an access network node or for each UE via a subscription request message;
wherein the subscription request message comprises a time synchronization
reporting type indicative of the type of time synchronization report requested; and
wherein the method further comprising:
receiving a time synchronization report message in response to the subscription request message, wherein the time synchronization report message comprises a time synchronization report.

93. The method of claim 88, the method further comprising: subscribing to UE location information for each UE via a location subscription request message.

94. The method of claim 88, wherein the one or more provider network entities determined to request a time synchronization status from include one or more of access network (AN) node, an access and mobility management function (AMF), a session management function (SMF), a user plane function (UPF), or Network Side Translator (NW-TT).

95. The method of claim 88, the method further comprising: determining binding for each UE with respect to an access network node.

96. The method of claim 88, wherein the network timing synchronization report is provided to the impacted UEs via non-access stratum (NAS) signaling, SIB9 signaling, RRC signaling, or PDU Session procedures signaling.

97. The method of claim 88, wherein causing the time synchronization report to be provided to one or more impacted UEs further comprises:
causing a network timing synchronization report to be provided to the UE included in a port management information container (PMIC).

98. The method of claim 88, wherein the network timing synchronization request indicates whether each information element included in the network timing synchronization status request are optional or mandatory in the time synchronization report.

99. The method of claim 88, wherein information elements of the network timing synchronization report comprise at least one of a primary source type, lock state, primary source event, or primary source quality.

100. An apparatus comprising at least one processor and at least one memory including computer program code for one or more programs, the at least one memory and the computer program code configured to, with the at least one processor, cause the apparatus at least to:
receive, at a network entity, a network timing synchronization status request, wherein the network timing synchronization status request includes an indication of one or more user equipment (UE) to provide a time synchronization report to;
determine, for each UE, one or more provider network entities to request a time synchronization status from;
in response to receiving an indication of a primary source event, generate a time synchronization report indicative of the primary source event; and
cause the time synchronization report to be provided to one or more impacted UEs.

101. An apparatus comprising at least one processor and at least one memory including computer program code for one or more programs, the at least one memory and the computer program code configured to, with the at least one processor, cause the apparatus at least to:
receive a time synchronization report; and
update one or more configurations based at least in part on the time synchronization report.

102. The apparatus of claim 101, wherein the at least one memory and the computer program code are further configured to, with the at least one processor, when updating one or more configurations, cause the apparatus at least to:
change a primary time source from which time information is received in response to receipt of the network timing synchronization status request.

103. The apparatus of claim 101, wherein the at least one memory and the computer program code are further configured to, with the at least one processor, when updating one or more configurations, cause the apparatus at least to:
rely on holdover capabilities for time information in response to receipt of the network timing synchronization status request

104. The apparatus of claim 101, wherein the at least one memory and the computer program code are further configured to, with the at least one processor, when updating one or more configurations, cause the apparatus at least to:
cause a grandmaster announcement update to be provided to an associated precise time protocol network.

105. The apparatus of claim 101, wherein the at least one memory and the computer program code are further configured to, with the at least one processor, when updating one or more configurations, cause the apparatus at least to:
cause a time source event report indicative of time source event to be provided to higher layers.

106. The apparatus of claim 101, wherein the at least one memory and the computer program code are further configured to, with the at least one processor, when updating one or more configurations, cause the apparatus at least to:
cause a network timing synchronization status request to be transmitted, wherein the time synchronization report is received in response to the network timing synchronization status request.

107. The apparatus of claim 101, wherein the network timing synchronization request indicates whether different information elements are optional or mandatory in the time synchronization report.
